(19) United States
(12) Patent Application Publication
(10) Pub. No.: US 2020/0104440 A1
(43) Pub. Date: Apr. 2, 2020

(54) METHOD FOR EVALUATING STATE OF POWER TRANSFORMER

(71) Applicant: WUHAN UNIVERSITY, HUBEI (CN)

(72) Inventors: Yigang HE, HUBEI (CN); Ming CHEN, HUBEI (CN); Liulu HE, HUBEI (CN)

(73) Assignee: WUHAN UNIVERSITY, HUBEI (CN)

(21) Appl. No.: 16/587,055

(22) Filed: Sep. 30, 2019

(30) Foreign Application Priority Data
Sep. 30, 2018 (CN) 201811154352.7

(51) Int. Cl. G06F 17/50

(52) U.S. Cl. CPC G06F 17/5009

(57) ABSTRACT

A power transformer state evaluation method is provided. The transformer is evaluated by the following steps: selecting an evaluation parameter, establishing a power transformer evaluation parameter system and collecting relevant parameter data; using the KLEE method to calculate the relative importance between the parameters, and then obtaining the weight of each parameter; establishing a collection of comments; finally determining the state level of the power transformer through the cloud model. The invention is applied to the technical field of power transformer state evaluation, and remedies the defects of existing transformer state evaluation methods, which are computationally complex and unable to achieve a balance between ambiguity and randomness, thereby improving the accuracy and objectivity of the transformer evaluation. The evaluation calculation is simple, and the subjective and objective aspects are taken into consideration.

### CROSS-REFERENCE TO RELATED APPLICATION

This application claims the priority benefit of China application serial no. 201811154352.7, filed on Sep. 30, 2018. The entirety of the above-mentioned patent application is hereby incorporated by reference herein and made a part of this specification.

### BACKGROUND

### Technical Field

The disclosure relates to the technical field of power facility state evaluation, in particular to a power transformer state evaluation method using a KLEE method and a cloud model.

### Description of Related Art

In recent years, large-scale electric accidents have occurred many times in local areas and other countries, which has caused people to pay attention to the operation safety of power systems. As a key facility of power systems, accurate evaluation on state of transformers are particularly important. Publication CN106295240A discloses a power transformer state evaluation method based on fuzzy mathematics, which processes the test data of the transformer based on modulus mathematical theory, and obtains a reliable state evaluation system under certain conditions, but does not take into consideration the randomness of faults. Publication CN106908674A discloses a transformer state evaluation method based on multi-state quantity prediction, which selects the main fault state quantity of the transformer, and is capable of performing comprehensive analysis on a large amount of state information of the transformer, thereby finding and predicting the potential fault of the transformer, but the calculation is complicated. Existing transformer state evaluation methods are computationally complex and unable to achieve a balance between ambiguity and randomness. Therefore, it is extremely necessary to adopt some new transformer state evaluation methods to improve some defects and problems of existing evaluation methods.

### SUMMARY

The technical problem to be solved by the present disclosure is to provide a power transformer state evaluation method that remedies the defects in conventional transformer state evaluation methods, which are computationally complex and unable to achieve a balance between ambiguity and randomness. The method in the present disclosure improves the accuracy and objectivity of the transformer evaluation while taking into consideration of ambiguity and randomness to ensure reliable operation of power transformers.

The technical solution adopted by the present disclosure to solve the above technical problems is:

A power transformer state evaluation method includes the following steps:

(1) Selecting the evaluation parameters, establishing a power transformer evaluation parameter system and collecting parameter data;

(2) Calculating the relative importance of parameters through the KLEE method, and then deriving the weight of each parameter;

(3) Establishing a collection of comments;

(4) Determining the state level of the power transformer through the cloud model.

Based on the above scheme, the power transformer evaluation parameter system in the step (1) includes a target layer, a factor layer and a parameter layer, and the target layer is a transformer state; the factor layer involves three items, including an oil chromatographic analysis, an electrical test, and an oiling test; the parameter layer involves 12 items, including hydrogen content, acetylene content, total hydrocarbon content, methane content, absorption ratio, polarization coefficient, winding dielectric loss, core leakage current, breakdown voltage, micro-water in oil, oil dielectric loss, and furfural content.

Based on the above scheme, the specific method of the step (2) is as follows:

21) Suppose there are n evaluation parameters that rank the parameters {aᵢ}, i=1, 2, . . . , n in a layer in descending order of importance {ãᵢ}, i=1, 2, . . . , n;

22) After the order rearrangement, the parameters are compared in terms of importance and quantified for presentation. Set the parameters as ãᵢ and ãᵢ₋₁, and their relative importance is represented by the weights wᵢ and wᵢ₋₁ of the corresponding parameters, then the importance Rᵢ of evaluation parameters is as follows:

wᵢ₋₁=Rᵢ₋₁=2, . . . ,n;

23) Benchmarking Rᵢ, obtaining Lᵢ after processing Rᵢ, setting the last evaluation parameter Lₙ as the reference, and making Lₙ=1, then calculating the processed value of the previous evaluation parameters from the end to the first through, the method is below:

$$\{ \begin{matrix}{L}_{i - 1} = {R}_{i - 1} \times {L}_{i} \\ {L}_{n} = 1\end{matrix} , i = 2 , … , n ;$$

24) The processed Lᵢ, i=1, 2, . . . , n are superimposed, and then Lᵢ is divided by the sum of superimposition, thereby calculating the normalized weight of each evaluation parameter, and the calculation method of normalized weight is as follows:

$${W}_{i} = \frac{{L}_{i}}{{\sum }_{i = 1}^{n} {L}_{i}} , i = 1 , 2 , … , n .$$

Based on the above scheme, the specific implementation method of the step (3) is as follows:

31) Based on the established transformer evaluation parameter system, establish the evaluation parameters of each level: U={U₁, U₂, . . . , Uₙ} represents the target layer parameters, and Uᵢ represents the i-th parameter of the target layer parameter U: Uᵢ={Uᵢ₁, Uᵢ₂, . . . , Uᵢₙ} is the factor layer parameter, Uᵢⱼ represents the j-th parameter of the factor layer parameter Uᵢ, wherein i=1, 2, . . . , n_{f}, n_{f} is the number the factor layer parameters, j=1, 2, . . . , nₚ is the number of parameter layer parameters;

32) Setting the collection of comments S to {normal, caution, abnormal, hazard}, set the collection of comments S to be in the range [0, 1], and the expression of the expectation Eₓᵢ and entropy value Eₙᵢ of the qualitative comment is:

$$\{ \begin{matrix}{E}_{xi} = \frac{{c}_{min} + {c}_{max}}{2} \\ {E}_{ni} = \frac{{c}_{max} - {c}_{min}}{6}\end{matrix}$$

Specifically, i=1, 2, . . . , n, the expectation Eₓᵢ is the point in space that best represents this qualitative concept, and the entropy value Eₙᵢ is used to measure the ambiguity and probability of the qualitative concept, cₘₐₓ=max {Eₓ₁, Eₓ₂, . . . , Eₓₙ}, cₘᵢₙ=min {Eₓ₁, Eₓ₂, . . . , Eₓₙ}.

Based on the above scheme, the specific implementation method of the step (4) is as follows:

41) Establishing a cloud model of quantitative parameters

For the quantitative evaluation parameters, the cloud model of the parameters in the transformer evaluation parameter system is established based on the method below:

$${E}_{x} = \frac{{E}_{x 1} + {E}_{x 2} + … + {E}_{xn}}{n}$$

$${E}_{n} = \frac{max ( {E}_{x 1} + {E}_{x 2} + … + {E}_{xn} ) - min ( {E}_{x 1} + {E}_{x 2} + … + {E}_{x n} )}{6}$$

Specifically, i∈[1, n];

42) Establishing a cloud model of qualitative parameters

For qualitative evaluation parameters, refer to historical operation data, and establish a cloud model through expert scoring, as follows:

$${E}_{x}^{′} = \frac{{E}_{x 1} {E}_{ n 1} + {E}_{x 2} {E}_{n 2} + … + {E}_{xn} {E}_{nn}}{{E}_{n 1} + {E}_{n 2} + … + {E}_{nn}}$$

$${E}_{n}^{′} = {E}_{n 1} + {E}_{n 2} + … + {E}_{nn}$$

43) Calculating the cloud's center of gravity vector of the comprehensive cloud

Each evaluation parameter in the system corresponds to a cloud model. Therefore, the n evaluation parameters correspond to n cloud models. When the evaluation parameters are changed, the comprehensive cloud changes, causing the position of the cloud's center of gravity to change, and the center of gravity of the n dimensional cloud model is expressed by an n dimensional comprehensive cloud's center of gravity vector T:

T=(T₁,T₂, . . . ,Tₙ)=a×b^{T}

Specifically, Tᵢ=aᵢ×bᵢ, i=1, 2, . . . , n, a represents the position vector of the cloud's center of gravity, b represents the height vector of the cloud's center of gravity (also represents the weight of each parameter), aᵢ represents the position vector of the cloud model of the i-th evaluation parameter, and bᵢ represents the height vector of the cloud model of the i-th evaluation parameter, that is, the normalized weight of the evaluation parameter is obtained through the step (2); when the evaluation parameter is changed, the cloud's center of gravity of comprehensive cloud becomes T′:

T′=(T₁′,T₂′, . . . ,Tₙ′)

44) Finding the degree of deviation

Under the ideal state, the position vector of the n dimensional cloud's center of gravity is a=(Eₓ₁⁰, . . . , Eₓ₂⁰, . . . , Eₓₙ⁰), and height vector thereof is b=(b₁, b₂, . . . , bₙ), so that the comprehensive cloud's center of gravity vector T⁰=a×b^{T}=(T₁⁰, T₂⁰, . . . , Tₙ⁰) is obtained under ideal conditions, and the cloud's center of gravity vector is normalized to obtain the normalized cloud's center of gravity vector T^{g}:

T^{g}=(T₁^{g},T₂^{g}, . . . ,Tₙ^{g})

The weighted deviation degree θ is obtained by the following equation:

$$θ = {\sum }_{i = 1}^{n} {T}_{i}^{g} \cdot {w}_{i}$$

The comprehensive deviation degree θ′ is:

$${θ}^{′} = {\sum }_{i = 1}^{n} {θ}_{i} \cdot {w}_{i}$$

Specifically, θ′ is the deviation degree of the upper level (target layer), θᵢ is the deviation degree of the lower level (factor layer);

45) Determining the evaluation results

The state level of the power transformer is determined based on the corresponding relationship between the calculation result of the comprehensive deviation degree and the evaluation level range of the comment collection in the transformer evaluation parameter system.

The disclosure has the advantageous effects that the disclosure adopts the KLEE method and the cloud computing to evaluate the state of the power transformer, remedies the shortcomings of conventional transformer state evaluation methods which are computationally complex and unable to achieve a balance between ambiguity and randomness in uncertainty of events, and improves the objectivity of evaluation, reduces subjective interference, has less calculation with higher accuracy, and decreases waste resource. The present disclosure establishes a hierarchical evaluation parameter system, which provides a new method for power transformer insulation state maintenance.

### BRIEF DESCRIPTION OF THE DRAWINGS

FIG. 1 is a flow chart of a power transformer state evaluation method according to the present disclosure.

### DESCRIPTION OF THE EMBODIMENTS

The specific embodiments of the present disclosure are further described in detail according to the technical solutions.

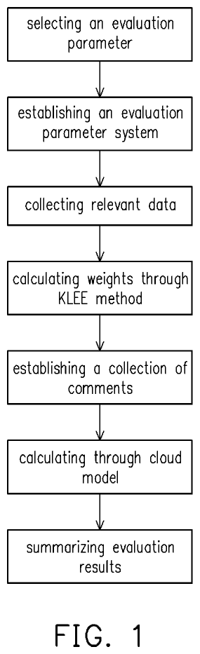

Referring to FIG. 1, a power transformer state evaluation method according to the present disclosure includes the following steps:

(1) Selecting evaluation parameters, establishing a power transformer evaluation parameter system and collect related data. The specific steps are as follows:

The power transformer evaluation parameter system described in the present disclosure is shown in Table 1, and includes three layers, namely a target layer, a factor layer and a parameter layer. The target layer is the transformer state; the factor layer involves three items, including an oil chromatographic analysis, an electrical test, and an oiling test; the parameter layer involves 12 items, including hydrogen content, acetylene content, total hydrocarbon content, methane content, absorption ratio, polarization coefficient, winding dielectric loss, core leakage current, breakdown voltage, micro-water in oil, oil dielectric loss, and furfural content.

TABLE 1
Transformer evaluation parameter system

| Target layer | Factor layer | Parameter layer |
|---|---|---|
| Transformer state | Oil chromatography | hydrogen content |
| | | acetylene content |
| | | total hydrocarbon content |
| | | methane content |
| | electrical test | absorption ratio |
| | | polarization coefficient |
| | | winding dielectric loss |
| | | core leakage current |
| | oiling test | breakdown voltage |
| | | micro-water in oil |
| | | oil dielectric loss |
| | | furfural content |

(2) Calculating the relative importance of parameters through the KLEE method, and then deriving the weight of each parameter. The specific method is as follows:

21) Suppose there are n evaluation parameters that rank the parameters {aᵢ}, i=1, 2, . . . , n in a layer in descending order of importance {ãᵢ}, i=1, 2, . . . , n;

22) After the order rearrangement, the parameters are compared in terms of importance and quantified for presentation. Set the parameters as ãᵢ and ãᵢ₋₁, and their relative importance is represented by the weights wᵢ and wᵢ₋₁ of the parameters, then the importance Rᵢ of evaluation parameters is as follows:

wᵢ₋₁=Rᵢ₋₁×wᵢ,i=1, . . . ,n;

The method of the present disclosure calculates the weights in a reverse order, so the importance degree of i−1 is calculated by the importance degree of i.

23) Benchmarking Rᵢ, obtaining Lᵢ after processing Rᵢ, setting the last evaluation parameter Lₙ as the reference, and making Lₙ=1, then calculating the processed value of the previous evaluation parameters from the end to the first through, the method is below:

$$\{ \begin{matrix}{L}_{i - 1} = {R}_{i - 1} \times {L}_{i} \\ {L}_{n} = 1\end{matrix} , i = 2 , … , n ;$$

24) The processed Lᵢ, i=1, 2, . . . , n are superimposed, and then Lᵢ is divided by the sum of superimposition, thereby calculating the normalized weight of each evaluation parameter, and the calculation method of normalized weight is as follows:

$${W}_{i} = \frac{{L}_{i}}{{\sum }_{i = 1}^{n} {L}_{i}} , i = 1 , 2 , … , n .$$

(3) Establishing a collection of comments through the specific implementation method as follows:

31) Based on the established transformer evaluation parameter system, establish the evaluation parameters of each level: U={U₁, U₂, . . . , Uₙ} represents the target layer parameters, and Uᵢ represents the i-th parameter of the target layer parameter U: Uᵢ={Uᵢ₁, Uᵢ₂, . . . , Uᵢₙ} is the factor layer parameter, Uᵢⱼ represents the j-th parameter of the factor layer parameter Uᵢ, wherein i=1, 2, . . . , n_{f}, n_{f} is the number the factor layer parameters, j=1, 2, . . . , nₚ is the number of parameter layer parameters;

32) Setting the collection of comments S to {normal, caution, abnormal, hazard}, set the collection of comments S to be in the range [0, 1], and the expression of the expectation Eₓᵢ and entropy value Eₙᵢ of the qualitative comment is:

$$\{ \begin{matrix}{E}_{xi} = \frac{{c}_{min} + {c}_{max}}{2} \\ {E}_{ni} = \frac{{c}_{max} - {c}_{min}}{6}\end{matrix}$$

Specifically, i=1, 2, . . . , n, the expectation Eₓᵢ is the point in space that best represents this qualitative concept, and the entropy value Eₙᵢ is used to measure the ambiguity and probability of the qualitative concept, cₘₐₓ=max{Eₓ₁, Eₓ₂, . . . , Eₓₙ}, cₘᵢₙ=min {Eₓ₁, Eₓ₂, . . . , Eₓₙ}.

(4) Determining the state level of the power transformer through the cloud model based on the specific implementation method as follows:

41) Establishing a cloud model of quantitative parameters

For the quantitative evaluation parameters (Eₓ, Eₙ), the cloud model of the parameters in the transformer evaluation parameter system is established based on the method below:

$${E}_{x} = \frac{{E}_{x 1} + {E}_{x 2} + … + {E}_{xn}}{n}$$

$${E}_{n} = \frac{max ( {E}_{x 1} + {E}_{x 2} + … + {E}_{xn} ) - min ( {E}_{x 1} + {E}_{x 2} + … + {E}_{xn} )}{6}$$

Specifically, Eₓᵢ represents the value of each parameter, i∈[1, n];

42) Establishing a cloud model of qualitative parameters

For qualitative evaluation parameters (E′ₓ, E′ₙ), refer to historical operation data, and establish a cloud model through expert scoring, as follows:

$${E}_{x}^{′} = \frac{{E}_{x 1} {E}_{n 1} + {E}_{x 2} {E}_{n 2} + … + {E}_{xn} {E}_{nn}}{{E}_{n 1} + {E}_{n 2} + … + {E}_{nn}}$$

$${E}_{n}^{ ′} = {E}_{n 1} + {E}_{n 2} + … + {E}_{nn}$$

43) Calculating the cloud's center of gravity vector of the comprehensive cloud

Each evaluation parameter in the system corresponds to a cloud model. Therefore, the n evaluation parameters correspond to n cloud models. When the evaluation parameters are changed, the comprehensive cloud changes, causing the position of the cloud's center of gravity to change, and the center of gravity of the n dimensional cloud model is expressed by an n dimensional comprehensive cloud's center of gravity vector T:

T=(T₁,T₂, . . . ,Tₙ)=a×b^{T}

Specifically, Tᵢ=aᵢ×bᵢ, i=1, 2, . . . , n, a represents the position vector of the cloud's center of gravity, b represents the height vector of the cloud's center of gravity, that is, the normalized weight of the evaluation parameter is obtained through the step (2); when the evaluation parameter is changed, the cloud's center of gravity of comprehensive cloud becomes T′:

T′=(T₁′,T₂′, . . . ,Tₙ′)

44) Finding the degree of deviation

Under the ideal state, the position vector of the n dimensional cloud's center of gravity is a=(Eₓ₁⁰, Eₓ₂⁰, . . . , Eₓₙ⁰) and height vector thereof is b=(b₁, b₂, . . . , bₙ), so that the comprehensive cloud's center of gravity vector T⁰=a×b^{T}=(T₁⁰, T₂⁰, . . . , Tₙ⁰) is obtained under ideal conditions, and the cloud's center of gravity vector is normalized to obtain the normalized cloud's center of gravity vector T^{g}:

T^{g}=(T₁^{g},T₂^{g}, . . . ,Tₙ^{g})

The weighted deviation degree θ is obtained by the following equation:

$$θ = {\sum }_{i = 1}^{n} {T}_{i}^{g} \cdot {w}_{i}$$

The comprehensive deviation degree θ′ is:

$${θ}^{′} = {\sum }_{i = 1}^{n} {θ}_{i} \cdot {w}_{i}$$

Specifically, θ′ is the deviation degree of the upper level (target layer), θᵢ is the deviation degree of the lower level (factor layer);

45) Determining the evaluation results

The state level of the power transformer is determined based on the corresponding relationship between the calculation result of the comprehensive deviation degree and the evaluation level range of the comment collection in the transformer evaluation parameter system.

Case Analysis

Taking a 220 kV main transformer in a substation as an example, a total of 4 sets of related parameters in one month were collected, and then the related parameters are normalized. The processed parameters are shown in Table 2.

TABLE 2
Normalized evaluation parameter values

| Parameters | 1 | 2 | 3 | 4 |
|---|---|---|---|---|
| Hydrogen content | 0.65 | 0.86 | 0.73 | 0.68 |
| acetylene content | 0.22 | 0.21 | 0.19 | 0.18 |
| total hydrocarbon content | 0.26 | 0.24 | 0.21 | 0.18 |
| methane content | 0.64 | 0.81 | 0.93 | 0.90 |
| absorption ratio | 0.33 | 0.02 | 0.11 | 0.15 |
| polarization coefficient | 0.24 | 0.32 | 0.44 | 0.47 |
| winding dielectric loss | 0.12 | 0.09 | 0.14 | 0.24 |
| core leakage current | 0.13 | 0.02 | 0.12 | 0.19 |
| breakdown voltage | 0.26 | 0.45 | 0.34 | 0.34 |
| micro-water in oil | 0.51 | 0.47 | 0.34 | 0.96 |
| oil dielectric loss | 0.55 | 0.78 | 0.85 | 0.72 |
| furfural content | 0.41 | 0.44 | 0.40 | 0.48 |

According to the evaluation parameter data of Table 2, the normalized weights of the evaluation parameters are calculated through the step (2), as shown in Table 3.

TABLE 3
Normalized weights of evaluation parameters, i.e., the height vector
b (each parameter weight) of the cloud's center of gravity

| Parameters | Weights |
|---|---|
| Hydrogen content | 0.080 |
| acetylene content | 0.049 |
| total hydrocarbon content | 0.032 |
| methane content | 0.034 |
| absorption ratio | 0.051 |
| polarization coefficient | 0.031 |
| winding dielectric loss | 0.089 |
| core leakage current | 0.046 |
| breakdown voltage | 0.043 |
| micro-water in oil | 0.083 |
| oil dielectric loss | 0.044 |
| furfural content | 0.062 |

The results of the evaluation parameter expectation and the entropy value calculated by the step (3) are as shown in Table 4, and the established comment collection is shown in Table 5.

Table 4 shows evaluation parameter expectation and entropy value, i.e., the position vector α of the cloud'scenter of gravity.

| Parameters | Expectation | Entropy Value |
|---|---|---|
| Hydrogen content | 180.756 | 4.144 |
| acetylene content | 0.240 | 0.013 |
| total hydrocarbon content | 114.805 | 1.622 |
| methane content | 8.689 | 0.418 |
| absorption ratio | 1.521 | 0.054 |
| polarization coefficient | 2.034 | 0.097 |
| winding dielectric loss | 0.298 | 0.285 |
| core leakage current | 26.595 | 1.037 |
| breakdown voltage | 50.785 | 0.987 |
| micro-water in oil | 16.020 | 1.026 |
| oil dielectric loss | 2.043 | 0.147 |
| furfural content | 0.291 | 0.024 |

TABLE 5
Comment collection (value range of qualitative comments)

| Comment | | | | |
|---|---|---|---|---|
| collection S | Normal | Caution | Abnormal | Hazard |
| Range | [0, 0.25] | [0.25, 0.5] | [0.5, 0.75] | [0.75, 1] |

According to Table 3 and Table 4, the comprehensive cloud's center of gravity vector T can be obtained as follows.
T=(1.330, 0.090, 2.184, 0.018, 0.094, 0.063, 0.027, 1.223, 14.460, 0.012, 3.674, 0.295)^{T}

The comprehensive cloud's center of gravity vector T⁰ under ideal state is as follows.
T⁰=(1.039, 0.134, 3.360, 0.015, 0.113, 0.079, 0.048, 0.913, 20.957, 0.016, 4.536, 0.404)^{T}

In the embodiment, θ is expressed as a vector of 12*1. Each number in the vector is the deviation degree of each parameter. For convenience of description, the deviation degree of 12 parameters is expressed in a vector, and then it can be obtained that the weighted deviation degree θ of each parameters is as follows.
θ=(0.28, 0.33, 0.35, 0.21, 0.17, 0.20, 0.44, 0.34, 0.31, 0.25, 0.19, 0.27)

Finally, the comprehensive deviation degree θ′ is as follows.
θ′=0.188.

Therefore, according to the corresponding relationship between the calculation result of the comprehensive deviation degree and Table 5, it can be determined that the 220 kV main transformer is in a normal state, and is in a tendency toward the caution state, therefore, the monitoring of the transformer should be reinforced.

It is apparent that the above-described embodiments are merely illustrative of the disclosure and are not intended to limit the embodiments of the disclosure. Other variations or modifications of various forms may be made by those skilled in the art in light of the above description. The obvious changes or variations that come within the spirit of the disclosure are still within the scope of the disclosure.

What is claimed is:

1. A power transformer state evaluation method, comprising the steps of:
(1) selecting an evaluation parameter, establishing a power transformer evaluation parameter system and collecting parameter data;
(2) calculating relative importance of parameters through a KLEE method, and then deriving the weight of each parameter;
(3) establishing a collection of comments; and
(4) determining a state level of a power transformer through a cloud model.

2. The power transformer state evaluation method according to claim 1, wherein the power transformer evaluation parameter system in the step (1) comprises a target layer, a factor layer and a parameter layer, and the target layer is a transformer state; the factor layer involves three items, comprising an oil chromatographic analysis, an electrical test, and an oiling test; the parameter layer involves 12 items, comprising hydrogen content, acetylene content, total hydrocarbon content, methane content, absorption ratio, polarization coefficient, winding dielectric loss, core leakage current, breakdown voltage, micro-water in oil, oil dielectric loss, and furfural content.

3. The power transformer state evaluation method according to claim 1, wherein the specific method of the step (2) is as follows:
21) supposing there being n evaluation parameters that rank the parameters {aᵢ}, i=1, 2, . . . , n in a layer in descending order of importance {ãᵢ}, i=1, 2, . . . , n;
22) after the order rearrangement, the parameters being compared in terms of importance and quantified for presentation, setting the parameters as ãᵢ and ãᵢ₋₁ with relative importance being represented by the weights wᵢ and wᵢ₋₁ of the corresponding parameters, then the importance Rᵢ of evaluation parameters being as follows:
wᵢ₋₁=Rᵢ₋₁×wᵢ,i=2, . . . ,n,
23) benchmarking Rᵢ, obtaining after processing Rᵢ, setting the last evaluation parameter Lₙ as the reference, and making Lₙ=1, then calculating the processed value of the previous evaluation parameters from the end to the first through, the method being below:
$$\{ \begin{matrix}{L}_{i - 1} = {R}_{i - 1} \times {L}_{i} \\ {L}_{n} = 1\end{matrix} , i = 2 , … , n ;$$
24) the processed Lᵢ, i=1, 2, . . . , n being superimposed, and then Lᵢ being divided by the sum of superimposition, thereby calculating the normalized weight of each evaluation parameter, and the calculation method of normalized weight being as follows:
$${W}_{i} = \frac{{L}_{i}}{{\sum }_{i = 1}^{n} {L}_{i}} , i = 1 , 2 , … , n .$$

4. The power transformer state evaluation method according to claim 3, wherein the specific implementation method of the step (3) is as follows:
31) based on the established transformer evaluation parameter system, establishing the evaluation parameters of each level: U={U₁, U₂, . . . , Uₙ} representing the target layer parameters, and Uᵢ representing the i-th parameter of the target layer parameter U: Uᵢ={Uᵢ₁, Uᵢ₂, . . . , Uᵢₙ} being the factor layer parameter, Uᵢⱼ representing the j-th parameter of the factor layer parameter Uᵢ, wherein i=1, 2, . . . , n_{f}, n_{f} is the number the factor layer parameters, j=1, 2, . . . , nₚ is the number of parameter layer parameters;
32) setting the collection of comments S to {normal, caution, abnormal, hazard}, setting the collection of comments S to be in a range [0, 1], and the expression of an expectation Eₓᵢ and an entropy value Eₙᵢ of the qualitative comment being:
$$\{ \begin{matrix}{E}_{xi} = \frac{{c}_{min} + {c}_{max}}{2} \\ {E}_{ni} = \frac{{c}_{max} - {c}_{min}}{6}\end{matrix}$$
specifically, i=1, 2, . . . , n, the expectation Eₓᵢ being a point in space that best represents this qualitative concept, and the entropy value Eₙᵢ being used to measure the ambiguity and probability of the qualitative concept, cₘₐₓ=max {Eₓ₁, Eₓ₂, . . . , Eₓₙ}, cₘᵢₙ=min {Eₓ₁, Eₓ₂, . . . , Eₓₙ}.

5. The power transformer state evaluation method according to claim 4, wherein the specific implementation method of the step (4) is as follows:
41) establishing a cloud model of quantitative parameters, wherein
for the quantitative evaluation parameters, the cloud model of the parameters in the transformer evaluation parameter system is established based on the method below:
$${E}_{x} = \frac{{E}_{x 1} + {E}_{x 2} + … + {E}_{xn}}{n}$$
$${E}_{n} = \frac{max ( {E}_{x 1} + {E}_{x 2} + … + {E}_{xn} ) - min ( {E}_{x 1} + {E}_{x 2} + … + {E}_{xn} )}{6}$$
wherein, i∈[1, n];
42) establishing a cloud model of qualitative parameters, wherein
for qualitative evaluation parameters, refer to historical operation data, and establish a cloud model through expert scoring, as follows:
$${E}_{x}^{′} = \frac{{E}_{x 1} {E}_{n 1} + {E}_{x 2} {E}_{n 2} + … + {E}_{xn} {E}_{nn}}{{E}_{n 1} + {E}_{n 2} + … + {E}_{nn}}$$
$${E}_{n}^{ ′} = {E}_{n 1} + {E}_{n 2} + … + {E}_{nn}$$
43) calculating a cloud's center of gravity vector of a comprehensive cloud, wherein
each evaluation parameter in the system corresponds to a cloud model, therefore, the n evaluation parameters correspond to n cloud models, when the evaluation parameters are changed, the comprehensive cloud changes, causing the position of the cloud's center of gravity to change, and the center of gravity of the n dimensional cloud model is expressed by an n dimensional comprehensive cloud's center of gravity vector T:
T=(T₁,T₂, . . . ,Tₙ)=a×b^{T}
specifically, Tᵢ=aᵢ×bᵢ, i=1, 2, . . . , n, a represents a position vector of the cloud's center of gravity, b represents a height vector of the cloud's center of gravity, aᵢ represents a position vector of the cloud model of the i-th evaluation parameter, and bᵢ represents a height vector of the cloud model of the i-th evaluation parameter, that is, the normalized weight of the evaluation parameter is obtained through the step (2); when the evaluation parameter is changed, the cloud's center of gravity of the comprehensive cloud becomes T′:
T′=(T₁′,T₂′, . . . ,Tₙ′)
44) finding the degree of deviation, wherein
under an ideal state, the position vector of the n dimensional cloud's center of gravity is a=(Eₓ₁⁰, Eₓ₂⁰, . . . , Eₓₙ⁰), and height vector thereof is b=(b₁, b₂, . . . , bₙ) so that the comprehensive cloud's center of gravity vector T⁰=a×b^{T}=(T₁⁰, T₂⁰, . . . , Tₙ) is obtained under ideal conditions, and the cloud's center of gravity vector is normalized to obtain the normalized cloud's center of gravity vector T^{g}:
T^{g}=(T₁^{g},T₂^{g}, . . . ,T^{g})
the weighted deviation degree θ is obtained by the following equation:
$$θ = {\sum }_{i = 1}^{n} {T}_{i}^{g} \cdot {w}_{i}$$
the comprehensive deviation degree θ′ is:
$${θ}^{′} = {\sum }_{i = 1}^{n} {θ}_{i} \cdot {w}_{i}$$
wherein, θ′ is a deviation degree of an upper level, θᵢ is a deviation degree of a lower level;
45) determining an evaluation result, wherein
a state level of the power transformer is determined based on a corresponding relationship between the calculation result of the comprehensive deviation degree and the evaluation level range of the comment collection in the transformer evaluation parameter system.
